(19) United States
(12) Patent Application Publication
(10) Pub. No.: US 2005/0168420 A1
(43) Pub. Date: Aug. 4, 2005

(54) Driving circuit of liquid crystal display

(76) Inventor: Kyung Hoon Chung, Kyoungki-do (KR)

Correspondence Address: LADAS & PARRY LLP, 224 SOUTH MICHIGAN AVENUE, SUITE 1600, CHICAGO, IL, 60604, US

(21) Appl. No.: 10/932,674

(22) Filed: Sep. 2, 2004

(30) Foreign Application Priority Data
Feb. 4, 2004 (KR) 2004-7289

(51) Int. Cl. G09G 3/36

(52) U.S. Cl. 345/87

(57) ABSTRACT

Disclosed is a liquid crystal display device having a wiring connected between a timing controller and each driver IC. The liquid crystal display includes gate driver ICs applying gate voltage to the liquid crystal panel, source driver ICs applying source voltage to the liquid crystal panel, a timing controller applying various control signals and data signals to each of the gate and source driver ICs, a data and control signal bus connected between the gate driver ICs and the timing controller and between the source driver ICs and the timing controller, and a clock wiring connected between the gate driver ICs and the timing controller and between the source driver ICs and the timing controller gate in order to transmit a clock signal outputted from the timing controller to each driver IC.

### BACKGROUND OF THE INVENTION

1. Field of the Invention

The present invention relates to a liquid crystal display device, and more particularly to a driving circuit of a liquid crystal display device allowing for a reducing the number of wirings, and improving usage efficiency of a bus by transmitting various data and control signals from a timing controller to each driver IC using a protocol.

2. Description of the Prior Art

In general, although a CRT (cathode ray tube), which is a kind of display device, is mainly used in monitors of televisions, various measurement apparatuses, and information terminals, a CRT has a heavy weight and a big size, so the CRT is not adaptable for electronic appliances having a small size and a light weight.

Accordingly, liquid crystal display devices having a slimmer and compact size with a light weight have been actively developed in order to substitute for CRTs. Recently, such liquid crystal display devices have been developed to serve as flat panel type display devices, and demand for such liquid crystal display devices has been significantly increased.

Such a liquid crystal display is a sort of flat panel type display device including two glass substrates and a liquid crystal layer filled between the two glass substrates. Herein, gate lines and data lines defining pixel regions are formed on a lower substrate of the liquid crystal display panel such that gate lines and data lines are aligned perpendicularly to each other. Also, a pixel electrode and a thin film transistor switched by a driving signal of the gate line in order to apply a signal of the data line to the pixel electrode, are aligned in each pixel region. In addition, a black matrix is aligned on an upper glass substrate of the liquid crystal display panel so as to prevent light from radiating into regions in which pixel electrodes are not formed. Also, a color filter layer is formed in each of the pixel regions by interposing the black matrix between pixel regions, and a common electrode is aligned at a front surface of the upper glass substrate.

FIG. 1 is a view showing a structure of a liquid crystal display device. Such liquid crystal display devices mainly include a liquid crystal panel 11 used for displaying images, in which a plurality of gate lines and data lines are aligned across to each other and thin film transistors are aligned at cross points of the gate lines and data lines, a source driver IC 13 for applying a driving voltage to the data lines of the liquid crystal panel 11, and a gate driver IC 15 for applying driving voltage to the gate lines of the liquid crystal panel 11.

In addition, even though there are not illustrated, the liquid crystal display device includes peripheral circuits, such as an LVDS unit and a timing controller, which apply various control signals to the source driver IC 13 and the gate driver IC 15.

Herein, referring to FIG. 2, the timing controller 21 outputs various control signals to a driver IC 23. At this time, the control signals are transmitted to corresponding driver ICs through various wiring, such as a clock signal applied by a clock wiring 25, a data signal applied by a data bus 27, and a control signal applied by a control signal bus 29.

FIG. 3 is a view showing signals transmitted from the timing controller 21 in a driving circuit of a conventional liquid crystal display device. Referring to FIG. 3, the data bus 27 is a wiring which transmits data signals to be displayed in a liquid crystal panel. Also, each of STH, LOAD and POL wirings is the control signal bus 29, in which an STH signal is transmitted to a driver IC through the STH wiring, and each of the LOAD and POL signals is transmitted to the driver IC through each the LOAD wiring and the POL wiring.

However, a driving circuit of the conventional liquid crystal display device has a problem, as follows.

That is, all control signals are created from the timing controller, and each of the control signals is transmitted to the corresponding driver ICs through mutually different wiring. As shown in FIG. 3, the control signals are only transmitted with a blank region other than a data input region, and a data signal is transmitted with the data input region other than the blank region, so the usage efficiency of each wiring is greatly lowered.

### SUMMARY OF THE INVENTION

Accordingly, the present invention has been made to solve the above-mentioned problems occurring in the prior art, and it is an object of the present invention to provide a driving circuit of a liquid crystal display device capable of efficiently using a wiring connected between a timing controller and each driver IC by transmitting data using a protocol.

Another object of the present invention is to provide a driving circuit of a liquid crystal display device allowing for a minimized number of wiring connected between a timing controller and each driver IC by transmitting data using a protocol.

In order to achieve the above objects, there is provided a driving circuit of a liquid crystal display for displaying an image by using gate and data voltages applied to a liquid crystal panel, the driving circuit of the liquid crystal display comprising: a plurality of gate driver ICs applying a gate voltage to the liquid crystal panel, a plurality of source driver ICs applying a source voltage to the liquid crystal panel, a timing controller applying various control signals and data signals to each of the gate and source driver ICs, a data and control signal bus connected between the gate driver ICs and the timing controller and between the source driver ICs and the timing controller in order to transmit a data packet outputted from the timing controller to each driver IC in a data input region, and to transmit a control packet to each driver IC in a blank region, and a clock wiring connected between the gate driver ICs and the timing controller and between the source driver ICs and the timing controller gate in order to transmit a clock signal outputted from the timing controller to each driver IC.

According to the preferred embodiment of the present invention, the data and control signal bus includes a first wiring transmitting a device ID and data, a second wiring transmitting data and existence of an STH signal, and a third wiring transmitting data. The wiring for transmitting data may further include a fourth wiring and a fifth wiring, if necessary.

Also, the data and control signal bus includes a first wiring transmitting a device ID and a control signal, and a second wiring transmitting the control signal. The wiring for transmitting a control signal may further include a third wiring and fourth wiring, if necessary.

Also, the data and control signal bus includes a first wiring transmitting a device ID and a register setting value, and a second wiring transmitting the register setting value. The wiring for transmitting the register setting value may further include a third wiring and fourth wiring, if necessary.

Meanwhile, the driver IC includes a receiver converting a signal inputted thereto from the timing controller to a signal used in the driver IC, a data processor processing a signal inputted thereto from the receiver into data to be displayed in the liquid crystal panel, an ID comparator comparing a device ID included in an inputted packet with an ID, which is given when initially setting the driver IC, a control signal generator creating a predetermined control signal when an STH or the control packet requests the control signal, and a control register storing an initial setting value of the driver IC. Each driver IC includes a transmitter transmitting all signals including the device IC, the STH and data from the data processor to a next driver IC, if the device ID included in the inputted packet is different from the ID, which is given when initially setting the driver IC.

### BRIEF DESCRIPTION OF THE DRAWINGS

The above object, features and advantages of the present invention will be more apparent from the following detailed description taken in conjunction with the accompanying drawings, in which:

FIG. 1 is a view showing a structure of a conventional liquid crystal display device;

FIG. 2 is a block view showing a structure of a driving circuit of a conventional liquid crystal display device;

FIG. 3 is a view showing various signals outputted from a timing controller shown in FIG. 2;

FIG. 4 is a block view showing a structure of a driving circuit of a liquid crystal display device according to the present invention;

FIG. 5 is a view showing a packet transmitted through data and control signal buses according to the present invention;

FIG. 6a is a view showing a structure of a data packet according to the present invention;

FIG. 6b is a view showing a structure of a control packet according to the present invention;

FIG. 6c is a view showing a structure of a packet for an initial setting of a driver IC according to the present invention;

FIG. 7 is a block view showing an internal structure of a driver IC according to a driving circuit of a liquid crystal display device of the present invention;

FIGS. 8 and 9 are views showing a connection between a timing controller and a driver IC formed by a driver IC having a block shown in FIG. 7;

FIG. 10 is an internal block view of a driver IC according to another embodiment of the present invention; and

FIG. 11 is a view showing a connection between a timing controller and a driver IC according to another embodiment of the present invention.

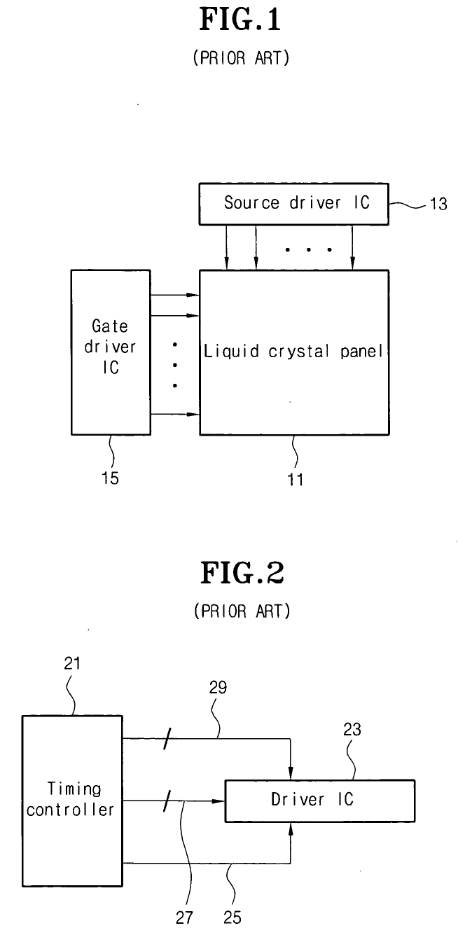

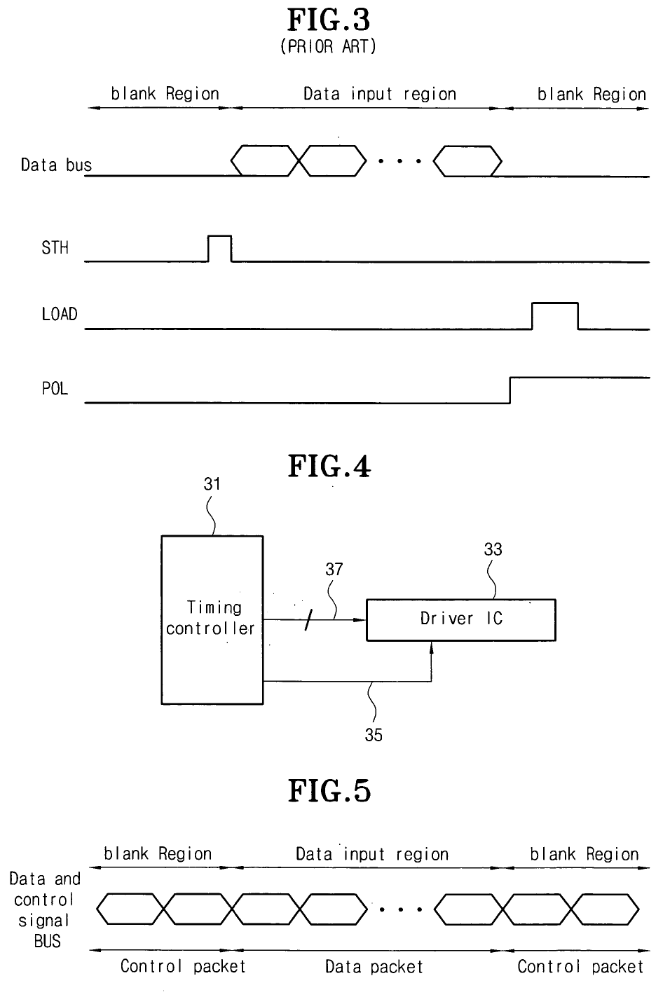

### DETAILED DESCRIPTION OF THE PREFERRED EMBODIMENTS

Hereinafter, preferred embodiments of the present invention will be explained with reference to the accompanying drawings.

FIG. 4 is a block view showing a structure of a driving circuit of a liquid crystal display device according to the present invention. Referring to FIG. 4, the driving circuit of the present invention includes a timing controller 31 and a driver IC 33. A clock wiring 35 and a data and control signal bus 37 are positioned between the timing controller 31 and the driver IC 33.

According to the present invention, a bus is more effectively used through reducing the number of wirings by transmitting control signals to each driver ICs by way of the data and control signal bus 37 at a blank region in which data is not inputted. Also, only the data and control signal bus 37 for transmitting data and various control signals and the clock wiring 35 for transmitting a clock signal are positioned between the timing controller and the driver IC, so data and various control signals can be transmitted through one bus regardless of the type of bus used.

To this end, a packet shown in FIG. 5 is used.

FIG. 5 is a view showing a packet transmitted through data and control signal buses according to the present invention. Referring to FIG. 5, a control packet is transmitted into a blank region, and a data packet is transmitted into a data input region through the data and control signal bus 37.

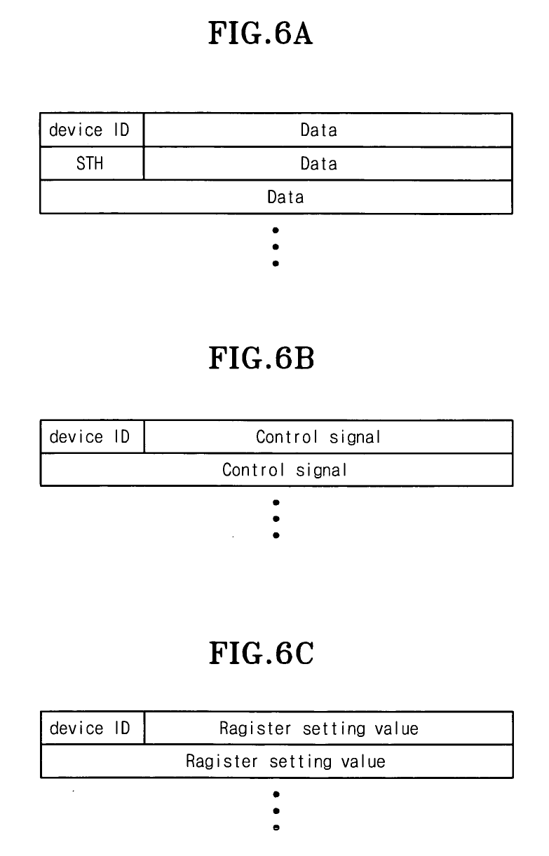

Meanwhile, FIG. 6a is a view showing a structure of a data packet according to the present invention, FIG. 6b is a view showing a structure of a control packet according to the present invention, and FIG. 6c is a view showing a structure of a packet for an initial setting of a driver IC according to the present invention. Referring to FIG. 6a, a device ID and data are transmitted through one wiring of buses. In addition, the other wiring transmits data and existence of an STH signal, and another wiring transmits data.

Referring to FIG. 6b showing the control packet, the device ID and data are transmitted through one wiring of the bus, and a control signal is transmitted through the other wiring.

Meanwhile, referring to FIG. 6c showing an initial setting of the driver IC, the device ID and a register setting value are transmitted through one wiring of the bus, and a register setting value is transmitted through the other wiring.

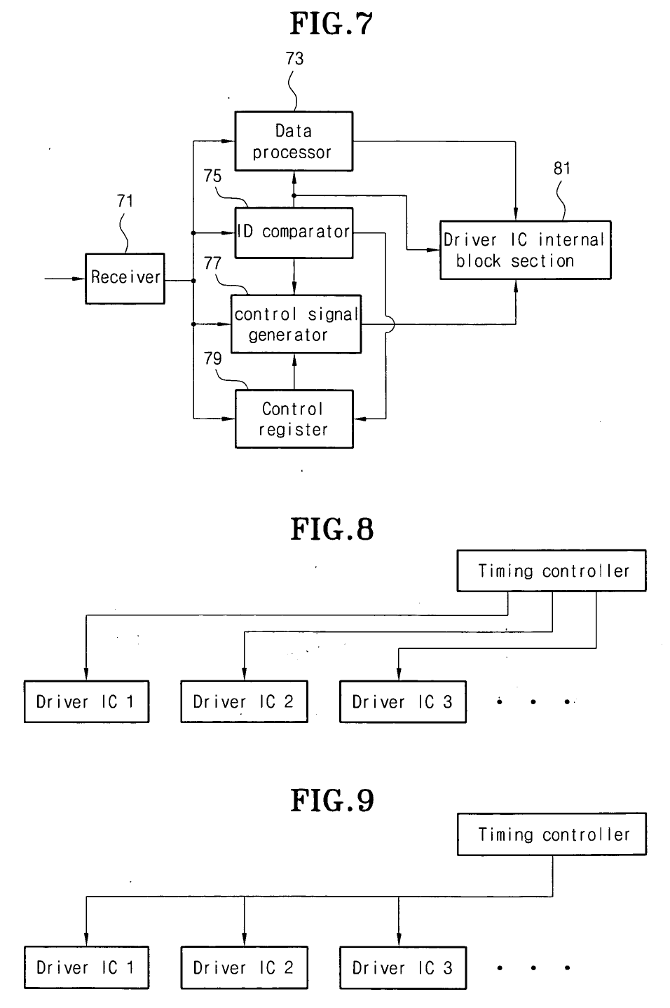

FIG. 7 is a block view showing an internal structure of a driver IC according to a driving circuit of a liquid crystal display device of the present invention. Herein, the driver IC includes a receiver 71, a data processor 73, an ID comparator 75, a control signal generator 77, a control register 79, and an internal block section 81 of the driver IC.

In the driver IC according to the present invention, the receiver 71 converts a packet inputted through a bus into a signal used in the driver IC, and the data processor 73 processes data to be displayed in a screen of a liquid crystal display device. Also, the ID comparator 75 compares a value given when the initial setting is carried out for the driver IC with the device ID of the packet.

In addition, the control signal generator 77 generates a predetermined control signal when an STH or the control packet requests the control signal, and the control register 79 stores the initial setting value of the driver IC therein.

Finally, the internal block section 81 of the driver IC receives the signal so as to output data to the screen of the liquid crystal display device in the same manner as the conventional driver IC.

Hereinafter, an operation of the driver IC will be explained with reference to the packet shown in FIGS. 6a to 6c.

Firstly, if a data packet as shown in FIG. 6a is inputted through the receiver 71, the ID comparator 75 compares the device ID of the inputted packet with the ID given when the initial setting is carried out for the driver IC. At this time, if the device ID of the inputted packet does not match with the device ID set in the driver IC, the driver IC makes the data processor 73 and the control signal generator 77 in a standby state without processing data in order to reduce power consumption.

If the device ID of the inputted packet is identical to the device ID, which is set when the initial setting is carried out for the driver IC, the data processor 73 transmits data inputted through the receiver 71 to the driver IC internal block section 81. At this time, if the packet requests a generation of the STH signal, the control signal generator 77 generates the STH signal. Also, if packet does not request the generation of the STH signal, the control signal generator 77 is maintained in the standby state.

Meanwhile, if the control packet as shown in FIG. 6b is inputted through the receiver 71, the ID comparator 75 compares the inputted device ID with the preset device ID, thereby recognizing that the control packet is inputted into the driver IC.

At this time, the ID comparator 75 may recognize the input of the control packet in various manners explained below.

For example, if device IDs given to each of the driver ICs 1 to 8 are in the range from 0001 to 1000, control signals are simultaneously inputted into all driver ICs, rather than inputted into each of driver ICs, so the ID comparator 75 senses the control packet when the inputted device ID is 1001.

That is, the device ID of the control packet is merely setting such that the device ID does not overlap with the device ID given to the driver IC.

If the control packet is inputted into the receiver 71, the data processor 73 is not used so that it is maintained in the standby-state. Also, the control signal generator 77 generates a signal in response to the control signal, and the generated signal is inputted into the driver IC internal block unit 81. At this time, the generation timing for the control signal is regulated according to the preset value, which is set in the control register 79.

Meanwhile, if the packet for the initial setting of the driver IC as shown in FIG. 6c is inputted into the receiver 71, the ID comparator 75 compares the inputted device ID with the preset device ID, so it is possible to recognize that the packet for the initial setting of the driver IC is inputted into the receiver 71. The packet is required for the initial setting of the driver IC before the driver IC is normally operated after power is inputted to the driver IC, so all driver ICs are simultaneously set.

Accordingly, the packet may be recognized as a packet for the initial setting of the driver IC by using a value, such as ‘0000’. If the packet is inputted into the receiver 71, the data processor 73, the control signal generator 77, and the driver IC internal block unit 81 are maintained in the standby state because they are not required to be operated, and each register is set based on the setting values inputted thereto.

At this time, the setting values are predetermined values for determining the generation timing of each control signal when device ID, STH, POL, and LOAD signals of each driver IC are required.

Of course, referring to FIGS. 6b and 6c, the control signal generation timing or initial setting values for the driver ICs may be set differently with each other. In this case, the device IDs must be distinguished from each other according to the driver ICs in the same manner as the data packet shown in FIG. 6a.

Meanwhile, FIGS. 8 and 9 are views showing a connection between a timing controller and a driver IC formed by using a driver IC having a block as shown in FIG. 7.

FIG. 8 shows a point to point manner in which each of driver ICs is connected to a timing controller through each bus, and FIG. 9 shows a multi-drop manner in which all driver ICs are connected to the timing controller through one bus.

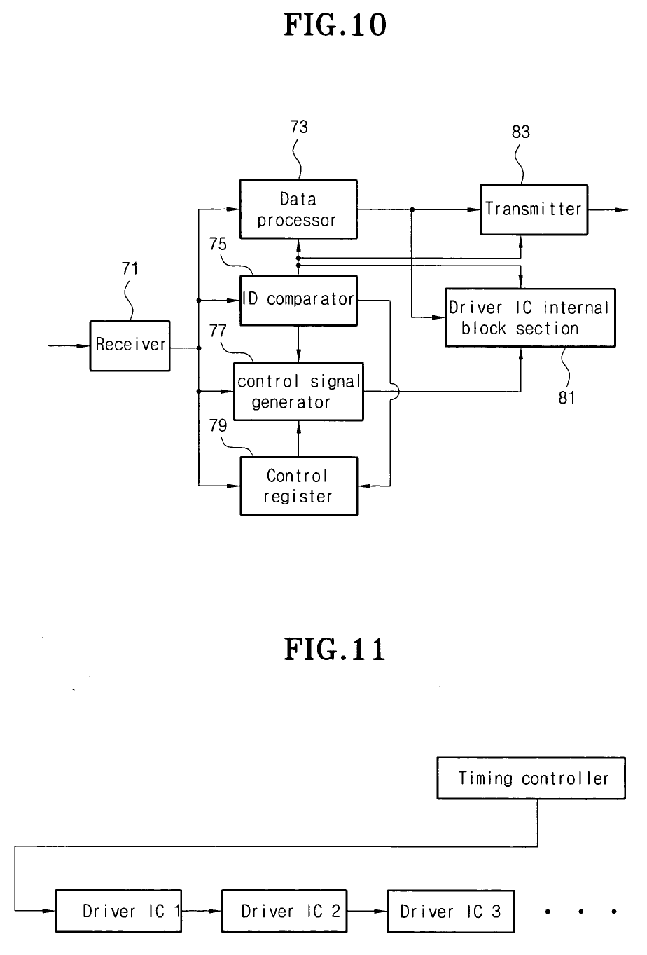

Meanwhile, FIG. 10 is an internal block view of a driver IC according to the present invention, in which a transmitter is added to a structure shown in FIG. 7, in order to realize a cascade connection as shown in FIG. 11.

Herein, an operation of the driver IC shown in FIG. 10 is substantially identical to the operation of the driver IC shown in FIG. 7, except that an operation of the transmitter 83 may be added to the operation of the driver IC shown in FIG. 10. For example, when a data packet as shown in FIG. 6a is inputted, if the device ID of the inputted packet is different from the preset device ID, the data processor 73 transmits all signals including device ID, STH, and data-signals to the transmitter 83 so as to transmit the signals to the next driver IC.

If the device ID of the inputted packet is identical to the preset device ID, an operation of the transmitter 83 is not required so that the transmitter 83 is maintained in a standby state.

That is, when the data packet as shown in FIGS. 6b and 6c is inputted, all driver ICs must be operated, so each of the driver ICs performs a predetermined operation allotted thereto while transmitting the data packet to next driver IC through the transmitter 83.

As described above, the driving circuit of the liquid crystal display device according to the present invention has advantages as follows.

Firstly, the driving circuit of the present invention transmits the packet from the timing controller to the driver IC by using a protocol, thereby reducing the number of wiring and improving efficiency of use for the bus.

Also, even if another control signal is added, new functions can be provided while maintaining the number of wiring, so that the driver IC has more functions with a reduced number of wiring.

By reducing the number of wiring, the number of wiring formed on a panel can be reduced when COG technique, such as source PCBless, is used so that a width of the wiring may be enlarged and the driver IC can be prevented from malfunctioning due to a voltage drop.

The preferred embodiment of the present invention has been described for illustrative purposes, and those skilled in the art will appreciate that various modifications, additions and substitutions are possible, without departing from the scope and spirit of the invention as disclosed in the accompanying claims.

1. A driving circuit of a liquid crystal display for displaying an image by using gate and data voltages applied to a liquid crystal panel, the driving circuit of the liquid crystal display comprising:
a plurality of gate driver ICs applying a gate voltage to the liquid crystal panel;
a plurality of source driver ICs applying a source voltage to the liquid crystal panel;
a timing controller applying various control signals and data signals to each of the gate and source driver ICs;
a data and control signal bus connected between the gate driver ICs and the timing controller and between the source driver ICs and the timing controller in order to transmit a data packet outputted from the timing controller to each driver IC in a data input region, and to transmit a control packet to each driver IC in a blank region; and
a clock wiring connected between the gate driver ICs and the timing controller and between the source driver ICs and the timing controller gate in order to transmit a clock signal outputted from the timing controller to each driver IC.

2. The driving circuit of the liquid crystal display as claimed in claim 1, wherein the data and control signal bus includes a first wiring transmitting a device ID and data, a second wiring transmitting data and existence of an STH signal, and a third wiring transmitting data, in order to transmit the data packet.

3. The driving circuit of the liquid crystal display as claimed in claim 1, wherein the data and control signal bus includes a first wiring transmitting a device ID and a control signal, and a second wiring transmitting the control signal, in order to transmit the control packet.

4. The driving circuit of the liquid crystal display as claimed in claim 1, wherein the data and control signal bus includes a first wiring transmitting a device ID and a register setting value, and a second wiring transmitting the register setting value, in order to transmit an initial setting value of the driver IC.

5. The driving circuit of the liquid crystal display as claimed in claim 1, wherein the driver IC includes a receiver converting a signal inputted thereto from the timing controller to a signal used in the driver IC, a data processor processing a signal inputted thereto from the receiver into data to be displayed in the liquid crystal panel, an ID comparator comparing a device ID included in an inputted packet with an ID, which is given when initially setting the driver IC, a control signal generator creating a predetermined control signal when an STH or the control packet requests the control signal, and a control register storing an initial setting value of the driver IC.

6. The driving circuit of the liquid crystal display as claimed in claims 1 or 5, wherein each driver IC includes a transmitter transmitting all signals including the device IC, the STH and data from the data processor to a next driver IC, if the device ID included in the inputted packet is different from the ID, which is given when initially setting the driver IC.
